(19) United States
(12) Patent Application Publication
(10) Pub. No.: US 2003/0221108 A1
(43) Pub. Date: Nov. 27, 2003

(54) Method for tamperproof marking of products

(76) Inventor: Paul Rupp, Schwalbach am Taunus (DE)

Correspondence Address: ROSS J. OEHLER, AVENTIS PHARMACEUTICALS INC., ROUTE 202-206, MAIL CODE: D303A, BRIDGEWATER, NJ, 08807, US

(21) Appl. No.: 10/434,934

(22) Filed: May 9, 2003

Related U.S. Application Data
(60) Provisional application No. 60/412,361, filed on Sep. 20, 2002.

(30) Foreign Application Priority Data
May 17, 2002 (DE) 10222569.9-53

(51) Int. Cl. H04L 9/00

(52) U.S. Cl. 713/176

(57) ABSTRACT

A method of marking commercial goods useful for preventing product tampering, particularly suitable for marking pharmaceutical and cosmetic products. The method uses a mark with an originality component which has an unencrypted identifier and an encrypted identifier. The purchaser or trader is able to verify the originator or producer of the product by comparing the unencrypted identifier with information obtained by reading and decrypting the encrypted identifier with a public key.

This application claims the benefit of U.S. Provisional Application No. 60/412,361 filed Sep. 20, 2002, and German Application No. 10222569.9, filed May 17, 2002.

### FIELD OF THE INVENTION

The present invention relates to a method for marking commercial products in an effort to prevent product tampering. More particularly, it relates to a marking method for pharmaceutical and cosmetic products by using a mark that includes both unencrypted information and encrypted information. Comparing the unencrypted information with the encrypted information, decrypted with a public key available to traders or purchasers, will provide indication whether the product's authenticity has been tampered.

### BACKGROUND OF THE INVENTION

Product tampering is a long-standing problem. Particularly medicine tampering with a lower quality of purity and/or composition than the original products puts the safety of patients at risk. According to the World Health Organization (WHO), 771 cases of medicament tampering had been reported by April 1999, where in 40% of 325 cases analyzed more closely the type or quality of the active components contained was incorrect, and 59% contained no active component. By way of example, the distribution and subsequent taking of paracetamol syrup which had been contaminated with the antifreeze diethylene glycol caused the death of 89 Haitians in 1995. In its guidelines for inspecting pharmaceutical products suspected to have been tampered with, contaminated or to be of lesser quality, the WHO recommends organoleptic examination of packaging and content of the product, followed either by simple analytical methods such as thin layer chromatography or by full analysis by the competent supervisory authorities (WHO publication WO/EDM/QSM/99.1, pages 1-5 and 33-37).

While organoleptic and simple analytical methods ensure only moderate safety, full analysis is generally complex and expensive.

In addition, medicaments are marked for traceability purposes on the distribution route from the manufacture to the trader and then to the consumer or patient, in order to allow direct access to particular batches of the product in the event of recalls, for example. The marking appears on the product in the form of plain text and, in the case of medicaments or cosmetics, contains a batch number, the expiry date and a clear article descriptor, for example the Pharmazentralnummer (PZN) [Central Pharmacology Number] for medicines. If appropriate, the unit for sale is additionally marked with the date of manufacture and with an individual serial number. All or some of this information is printed not only in plain text but also in the form of a one-dimensional or two-dimensional code which can be read by machine.

Recently, attempts have been made to show that medicaments are authentic by applying antitampering features similar to those on bank notes, entailing considerable manufacturing cost and logistical complexity. By way of example, an initiative from the Italian Ministry of Health requires all medicament packaging to bear a nine-digit serial number which needs to be produced by the Italian national mint (Focus, periodical of the International Federation of Pharmaceutical Wholesalers, Inc., vol. 8, No. 25, Dec. 27, 2001). German laid open DE 100 19 721 Al describes a method for tamperproof marking of products wherein a product is marked with an encrypted first marking and a repackaging is marked an encrypted second marking, and wherein the second marking depends on the encrypted information in the first marking and thus allows for the conclusion that the product is in the correct repackaging.

The European patent EP 360 225 B1 describes an apparatus for marking postal messages with indicia wherein the indicia have the form of an array of pixel, e.g. a two-dimensional matrix code, and the information is encrypted by a public key generated with an asymmetric encryption method. According to said method the status of the payment of postage can be determined.

### SUMMARY OF THE INVENTION

It is an object of the present invention to provide a method which can be used to check the authenticity of products, particularly of medicaments, in a simple and inexpensive manner.

Accordingly, the subject matter of the present invention is a method for marking a product, where

1. the product is marked with at least one originality component comprising at least one individual identifier in unencrypted form (A) and at least one individual identifier in encrypted form (B),

2. the unencrypted identifier (A) contains at least one individual identification number and optionally one or more further features,

3. the encrypted identifier (B) is produced from the content of the unencrypted identifier (A), and

4. the originality component is provided in plain text or in machine-readable form.

For practical handling and automatic control, the originality component can be converted into a machine-readable code. By decrypting the encrypted identifier, it is possible to infer the originality of the product.

Within the meaning of the present invention, product means a commercial good in any form, for example a pharmaceutical product or a cosmetic, preferably blood banks, blister packs, ampoules, vials, syringes, tablets, capsules, cachets, suckable tablets, plasters, tubes, inhalers, spray bottles, and/or a packaging or repackaging or a packaging combination therefor.

The originality feature can contain between 1 and 1 000 characters; preferably, the unencrypted individual identifier (A) contains between 5 and 30 characters and the encrypted individual identifier (B) contains between 30 and 300 characters.

Further features within the meaning of the present invention are

1. an article number, preferably a PZN, an EAN (European Article Number), UPC (Universal Product Code), NDC (National Drug Code) or NHRIC (National Health Related Item Code), and/or

2. a batch number, and/or

3. the date of manufacture, and/or

4. the expiry date, and/or

5. an identifier for the packaging or repackaging, and/or

6. other numbers marking the product.

In one particular embodiment, the individual identification number is formed from the article number, preferably the PZN, the batch number and a serial number within the batch.

The originality components can be provided in machine-readable form or in plain text. In addition, the originality components can comprise any characters, preferably letters, digits, special characters and/or patterns; with particular preference, the originality components are numeric or alphanumeric. Preferably, the originality components are shown in machine-readable form, and particularly preferably in the form of a two-dimensional code.

The originality components can also be applied to the product in a form stored in a magnetic strip or in a chip.

A code can be black and white, black on white or white on black, or colored or multicolored.

A code can be applied to the product by virtue of the product being printed or labeled, in which case any type of printer can be used, for example an inkjet printer, a laser printer, a laser marker, a dot matrix printer, a wire matrix printer or a thermal transfer printer.

A machine-readable code can be read using a commercially available scanner, for example using a laser scanner or a CCD camera, for example the Imageteam® 440 unit from the company WelchAllyn®, Dornstetten, Germany.

A one-dimensional code is code 39, extended code 39 or code 128, for example.

Examples of two-dimensional codes are 3D barcode, 3-DI, ArrayTag, Aztec code, small Aztec code, codablock, code 1, code 16K, code 49, CP code, data glyphs, data matrix code, datastrip code, dot code A, hueCode, MaxiCode, MiniCode, PDF417, Micro PDF417, QR code, SmartCode, Snowflake Code, SuperCode, Ultracode (company brochure from the company Barcodat “2D-Code-Fibel, Systematisierung und Lesegerate”, Barcodat GmbH, Dornstetten, Germany, March 1998). The preference is the data matrix code (Code ECC 200, International Symbology Specification—Data Matrix; ANSI/AIM BC11-1997, May 8, 1997, published by AIM International Inc., Reston, USA).

The data matrix code is a two-dimensional machine-readable symbol code which can be used to store between 1 and 3 116 numeric or 2 335 alphanumeric characters or 1 556 bytes of binary information. The data matrix code comprises 4 fundamental components: a fixed limit, a broken limit, a data storage area and a “QuietZone”.

The fixed limit allows the decoder to calculate the orientation of the data matrix code. The broken limit allows the decoder to determine the number of columns and rows or the matrix density. The data storage area contains the binary information which has been coded during production of the data matrix code. The “Quiet Zone” is an unprinted zone which encloses the data matrix and has a different color than the fixed limit. If the fixed limit has a dark color such as black, the “Quiet Zone” is light, preferably white.

Each coded character within the data matrix is represented by a binary code comprising 8 bits. The character “M” is “01001101”, for example, where “1” is preferably a dark zone within the data matrix and “0” is a light zone.

As compared with the barcode, the data matrix code has the advantage that it affords more storage space and increased readability as a result of the error correction method (ECC), which means that lesser demands are placed on the printer and on the area requirement.

For encryption, an asymmetric method is used in which the individual identifier (A) is encrypted using the secret part (e) of the key. Data encrypted using the secret part of the key can only be decrypted using the public part (d) of the key. It can therefore be concluded that encrypted data which can be decrypted using the public part of the key (d) were encrypted using the secret part of the key (e). Since the secret part of the key is not accessible to the public, this allows the originator or producer of the data and hence of the product to be proved without any doubt.

Asymmetric encryption methods are, by way of example, the method from Rivest, Shamir and Adleman (RSA method), McEliece, ElGamal, LUC or from Diffie Hellman.

The preference is the RSA method for key generation and encryption, as described in U.S. Pat. No. 4,405,829, for example. This method defines not only the keys (d) and (e) but also the publicly accessible modulus (n) required for encrypting and decrypting the data. The basis of this method is that, when selecting primary numbers p and q of appropriate size for generating the modulus (n), where n=p**q, it is not possible to use known computers and mathematical methods to infer the secret key in a reasonable time and at reasonable cost.

The degree of encryption is geared to the length of the key used.

Preferably, a key having a length greater than or equal to 1 024 bits is used on the basis of an RSA modulus of at least 309 decimal numbers.

The purchaser of and/or trader in the product marked in accordance with the invention is provided with the public part of the key (d) and with the modulus (n); by way of example, this part of the key can be stored on a publicly accessible data server or on the Internet or can appear on the product.

The method allows the purchaser and/or trader to determine the manufacturer of the product beyond doubt so long as the secret part of the key (e) is not published.

For decryption, the originality components are read and the encrypted individual identifier (B) is decrypted using the public part of the key. If the identifier obtained after the encrypted part (B) has been decrypted corresponds to the identifier in unencrypted form (A), this means that, firstly, the encrypted part (B) has been produced using the secret part of the key, and that, secondly, the source or the manufacturer of the product has therefore produced the encrypted part (B), and that, thirdly, the source or the manufacturer of the product has therefore been identified as the owner of the secret part of the key.

The inventive method allows product tampering to be detected: if the individual identifier obtained when the encrypted identifier (B) has been decrypted using the public key (d) and the modulus (n) corresponds to the individual identifier which the unencrypted identifier (A) contains, then the individual identifier has been produced by the owner of the secret key (e).

The individual identifier is used only once. Identical copies of the product can therefore be recognized by comparing the individual identification number with individual identification numbers already used which have been registered by the retailer, trader or customer or have been published by the manufacturer. Serial copies can easily be established in retail through serial recognition.

Serial tampering and product tampering can additionally be made more difficult, which involves

1. the product and/or the packaging or repackaging being marked with at least one originality component comprising at least one individual identifier in unencrypted form (A) and at least one individual identifier in encrypted form (B),

2. the unencrypted form (A) of the product identifier being additionally adopted as part of the repackaging's message which is to be encrypted and which bears a separate identifier (identifier for the repackaging), and which involves

3. the originality of the repackaging and of the individual products it contains being distinguished in that the decoded message needs to contain not only the identifier for the repackaging but also the product's originality component, wherein

4. the identifier of the repackaging is independent from the product identifier.

The difficulty in tampering lies in that the product identifier also needs to be tampered with. Otherwise, serial tampering will actually be recognized for individual packaging.

With simple repackaging, without altering the primary packed goods (product) and producing serial tampering, the risk of discovery is thus much greater.

The inventive method is also suitable as protection against tampering with the expiry date. Many consumer articles, such as pharmaceutical products, cosmetic products or groceries, are provided with a use-by or expiry date. To be able to continue to sell products whose use-by time has completely or partially expired, third parties dishonestly manipulate the use-by/expiry date.

This manipulation can be prevented if the use-by or expiry date is encrypted using the methods described in the patent. The method comprises the following elements and method steps:

1. the use-by or expiry date is part of the unencrypted form (A) of the product identifier and is encrypted using a private key from an asynchronous encryption method;

2. the result of encryption (encrypted message) and the unencrypted use-by or expiry date are applied to the sales packaging. The encrypted message is preferably applied in machine-readable form using a one-dimensional or two-dimensional code such as the data matrix code or using other electronically readable methods, such as magnetic strips, memory chips, transponders or using biocoded methods;

3. the consumer or the trader is able to check the originality of the use-by or expiry date by decoding the encrypted message using the associated public key and obtaining the original use-by or expiry date in the decoded message, provided that said date matches the use-by or expiry date appearing in unencrypted form.

The difficulty in manipulating the use-by or expiry date is in the application of the asynchronous encryption described in the patent. Only with knowledge of the private key is it possible to generate a decoded message which, following decryption using public keys, matches the undecoded message.

The private key can be determined by third parties only using extremely time-consuming computation methods. With keys of appropriate length, the computation time is longer than the use-by/expiry time. This makes it possible to prevent manipulation by third parties using this method, provided that the private key is kept safely and the encrypted message is always part of the product.

The various features of novelty which characterize the invention are pointed out with particularity in the claims annexed to and forming a part of this disclosure. For a better understanding of the invention, its operating advantages, and specific objects attained by its use, reference should be made to the drawings and the following description in which there are illustrated and described preferred embodiments of the invention.

### BRIEF DESCRIPTION OF THE DRAWINGS

FIG. 1 is a diagram showing the process of encrypting individual identification number as part of the marking method of the present invention.

FIG. 2 is a sample mark produced according to the present invention to be applied to the packaging, showing the originality feature and encrypted message as date matrix code.

FIG. 3 shows the process by which a retailer, pharmacist or patient may check for authenticity of the product.

### DETAILED DESCRIPTION OF PARTICULAR EMBODIMENTS

Examples 1 to 7 demonstrate the inventive principle with a reduced volume of data, where the message to be encrypted is a letter.

Examples 8 and 9 illustrate an embodiment of the inventive method, where the message to be encrypted is around 47 ASCII characters and the key length is several hundred bits.

### EXAMPLE 1

Principle of Generating the Private and Public Keys using Encryption based on the RSA Method

Search for a modulus

n=p q (p and q are primary numbers)

with the primary numbers p and q gives p=17, q=23, for example

Euler's PHI function applies, which indicates the number of all integers smaller than n which are aliquant parts of n:

PHI(n)=(p−1)(q−1)

Example: PHI(n)=352

Two numbers e and d must be found for which

e d mod PHI(n)=1 applies.

First, d is chosen such that d is relatively prime with respect to PHI(n). The ideal is a primary number

d>max(p,q) and d<PHI(n)−1.

In order to find e, it is necessary to find a solution with integer x and y for the equation

x d+y PHI(n)=1.

The following applies:

x d=1 (mod PHI(n)).

If the following is set:

e=x mod PHI(n),

then

e d=1 (mod PHI(n))

as well.

e and d are the keys, n is the “modulus” or modulo.

The encryption function is E(x)=x^{e} mod n,

the decryption function is D(x)=x^{d} mod n.

Since modulo n is calculated for the functions E(x) and D(x), x must be <n. Each message X needs to be divided into blocks x1, x2, . . . such that x1, x2 . . . are <n.

### EXAMPLE 2

Program for key generation, conversion of the message into ASCII code, encryption, decryption, conversion of the decrypted ASCII code into plain text and verification

The program runs on 80×86 PCs using Microsoft 32-bit Windows (NT/2000/XP/95B/98/ME). It was written in Microsoft Visual Basic 6.0.

VERSION 5.00
Begin {C62A69F0-16DC-11CE-9E98-00AA00574A4F} UserForm 1

| | |
|---|---|
| Caption = | “RSA-Test” |
| ClientHeight = | 10620 |
| ClientLeft = | 45 |
| ClientTop = | 330 |
| ClientWidth = | 12765 |
| OleObjectBlob = | “UserForm1.dsx”:0000 |
| StartUpPosition = | 1 'window center |

End
Attribute VB_Name = “UserForm 1”
Attribute VB_GlobalNameSpace = False
Attribute VB_Creatable = False
Attribute VB_PredeclaredId = True
Attribute VB_Exposed = False
Function Findkey(ByVal p, ByVal q As Long) As Long

Dim maxpq, random, difference, phin As Long

If p > q Then

maxpq = p

Else

maxpq = q

```
  End If
  phin = (p − 1) * (q − 1)
  difference = phin − maxpq
  Randomize
  Do
```

random = Int(Rnd * difference) + maxpq

```
  Loop Until lstPrime(random)
  Findkey = random
End Function
Function lstPrime(ByVal a As Long) As Boolean
Dim factor, root a As Long
Dim prime As Boolean
Prime = True
factor = 2
root a = Int(Sqr(a))
While (factor < = root a) And Prime
If a Mod factor = 0 Then
  Prime = False
End If
factor = factor + 1
Wend
1st Prime = prime
End Function
Function FindOtherKey(ByVal p, ByVal q, ByVal e As Long) As Long
  Dim d, phin As Long
  phin = (p − 1) * (q − 1)
  d = 0
  Do
```

d = d + 1

```
  Loop Until ((e * d ) Mod phin = 1) Or (d > phin)
  If d > phin Then
```

d = 0

```
  End If
  FindOtherKey = d
End Function
Function ahochbmodc(ByVal a As Long, ByVal b, ByVal c As Long)
As Long
  Dim n, i, m, m2 As Long
  n = a Mod c
  m2 = 1
  Do
```

```
If b > 2 Then
  i = n \hat{ } 3
  b = b − 3
Else
  i = n \hat{ } b
  b = 0
End If
m = i Mod c
m2 = m * m2
m2 = m2 Mod c
```

```
  Loop Until b = 0
  ahochbmodc = m2
End Function
Private Sub encrypt(ByVal unencryp As String, ByRef encryp As String,
ByVal e, ByVal n As Long)
Dim numerator, aux As Long
For numerator = 1 To Len (unencryp)
  aux = ahochbmodc(Asc(Mid(unencryp, numerator, 1)), e, n)
  encryp = encryp + CStr(aux) + “ ”
Next numerator
End Sub
Private Sub decrypt(ByVal encryp As String, ByRef unencryp As String,
ByVal d, ByVal n As Long)
Dim numerator1, numerator2, value_aux1, value_aux2 As Long
Dim auxstring1 As String
auxstring1 = “ ”
numerator1 = 1
Do
  numerator2 = numerator1
  Do
```

numerator2 = numerator 2 + 1

```
  Loop Until (Mid(encryp, numerator2, 1) = “ ”) Or (numerator2 > Len
  (encryp))
  If numerator2 < = Len (encryp) Then
```

value_aux1 = CLng (Mid(encryp, numerator1,
numerator2 − numerator1))
value_aux2 = ahochbmodc(value_aux1, d, n)
auxstring1 = auxstring 1 + Chr(value_aux2 Mod 256)
numerator1 = numerator2 + 1

```
  End If
Loop Until numerator1 > = Len(encryp)
unencryp = auxstring1
End Sub
Private Sub ascii_dec(ByVal text1 As String, ByRef text2 As String)
Dim numerator, aux As Long
For numerator = 1 To Len (text1)
  aux = Asc(Mid(text1, numerator, 1))
  text2 = text2 + CStr(aux) + “ ”
Next numerator
End Sub
Private Sub ascii_enc(ByVal text1 As String, ByRef text2 As String)
Dim numerator1, numerator2, value_aux1 As Long
Dim auxstring1 As String
auxstring1 = “ ”
numerator1 = 1
Do
  numerator2 = numerator1
  Do
```

numerator2 = numerator2 + 1

```
  Loop Until (Mid(text1, numerator2, 1) = “ ”) Or
  (numerator2 > Len(text1))
  If numerator2 < = Len(text1) Then
```

value_aux1 = CLng(Mid(text1, numerator1,
numerator 2 − numerator1))
auxstring1 = auxstring1 + Chr(value_aux1)
numerator1 = numerator2 + 1

```
  End If
Loop Until numerator1 > = Len(text1)
text2 = auxstring1
End Sub
Private Sub btn_decryp_Click( )
  Dim tempstring2 As String
  tempstring2 = “ ”
  If Right(txt_encryp.Text, 1) < > “ ” Then
```

txt_encryp.Text = txt_encryp.Text + “ ”

```
  End If
  Call decrypt(txt_encryp.Text, tempstring2, txt_d, txt_n)
  txt_unencryp.Text = tempstring2
  tempstring2 = “ ”
  Call ascii_dec(txt_unencryp.Text,tempstring2)
  txt_unencryp_ascii.Text = tempstring2
  txt_concat.Text = txt_unencryp_ascii.Text + “/” + txt_encryp.Text
End Sub
Private Sub btn_generate_Click( )
  lab_n_gen.Caption = txt_p_gen * txt_q_gen
  lab_phin_gen.Caption = (txt_p_gen − 1) * (txt_q_gen − 1)
  lab_e_gen.Caption = Findkey(txt_p_gen, txt_q_gen)
  txt_e = lab_e_gen.Caption
  txt_n = lab_n_gen.Caption
  lab_d_gen.Caption = FindOtherKey(txt_p_gen, txt_q_gen,
  lab_e_gen.Caption)
  txt_d = lab_d_gen.Caption
End Sub
Private Sub btn_del_unencryp_Click( )
  txt_unencryp.Text = “ ”
  txt_unencryp_ascii.Text = “ ”
  txt_concat.Text = “ ”
End Sub
Private Sub btn_del_encrypClick( )
  txt_encryp.Text = “ ”
  txt_concat.Text = “ ”
End Sub
Private Sub btn_key_gen_Click( )
  fram_key_gen.Visible = Not fram_key_gen.Visible
End Sub
Private Sub btn_verifi_Click( )
  Dim auxstring1, auxstring2 As String
  auxstring1 = “ ”
  auxstring2 = “ ”
  If InStr(1, txt_verifi.Text, “/”) >0 Then
    auxstring1 = Left(txt_verifi.Text, InStr(1, txt_verifi.Text, “/”) − 1)
    Call ascii_enc(auxstring1, auxstring2)
    txt_unencryp_verifi.Text = auxstring2
    auxstring1 = “ ”
    auxstring2 = “ ”
    auxstring 1 = Right(txt_verifi.Text, Len(txt_verifi.Text) − InStr(1,
    txt_verifi.Text, “/”))
    If Right(auxstring1, 1) < > “ ” Then
```

auxstring1 = auxstring1 + “ ”

End If
Call decrypt(auxstring1, auxstring2, txt_d, txt_n)
txt_decryp_verifi.Text = auxstring2

background_color = lab_ident.BackColor

```
If StrComp(txt_decryp_verifi.Text, txt_unencryp_verifi.Text) Then
  lab_ident.Caption = “NOT AUTHENTIC”
  lab_ident.BackColor = RGB(255, 0, 0)
  Beep
Else
lab_ident.Caption = “AUTHENTIC”
lab_ident.BackColor = RGB(0, 255, 0)
End If
End If
End Sub
Private Sub btn_encryp_Click( )
  Dim tempstring As String
  tempstring = “ ”
  Call encrypt(txt_unencryp.Text, tempstring, txt_e, txt_n)
  txt_encryp. Text = tempstring
  tempstring = “ ”
  Call ascii_dec(txt_unencryp. Text, tempstring)
  txt_unencryp_ascii. Text = tempstring
  txt_concat.Text = txt_unencryp_ascii.Text + “/” + txt_encryp.Text
End Sub
Private Sub lab_ident_Click( )
  lab_ident.Caption = “ ”
  lab_ident.BackColor = UserForm1.BackColor
End Sub
```

### EXAMPLE 3

Converting message to be encrypted into encrypted bit pattern or numerical sequence

Using the program code illustrated in example 2, a

| | |
|---|---|
| private key = | 185, a |
| public key = | 137, and the |
| modulus = | 391 are produced. |

The message to be encrypted is the letter “A”, which as a decimal number corresponding to the ASCII code is the number 65 and corresponds to the binary digit sequence 0100 0001.

For encryption, the message is encrypted using the private part of the key.

The encryption function is

E(x)=x^{e} mod n, hence in this example

E(x)=65¹⁸⁵ mod 391=241 The encrypted message is 241 in decimal notation and is 1111 0001 as a binary number.

### EXAMPLE 4

Producing Message and Code in Data Matrix Code ECC200, Marking the Product

From the encrypted message generated in example 3 in unencrypted and encrypted form and, in each case, in binary form, a data matrix code was produced and shown in line with the rules in “AIM International Symbology Specification Data Matrix, Annex M” using the Wolke Drucksystem m600 (Controller Art. No. 620100):

[image]

The data matrix code shown was printed onto a medicament packaging using a data matrix code printer, for example Wolke Drucksystem m600/Printhead Art. No.620300.

Likewise, the unencrypted message was printed onto the packaging in decimal and binary notation.

### EXAMPLE 5

Reading the Information contained in the Data Matrix Code

Information contained in the data matrix code can be read by retailers using a fixed code reader, for example commercially available makes from Pharma Controll Electronic GmbH, type: Camera Data Matrix Control System.

A check for serial tampering is made by means of comparison with already known identification numbers.

In the pharmacy, the information contained in the data matrix code is read, by way of example, using handheld readers, such as the make Welch Allyn Inc., type: 4410HD-131CK.

### EXAMPLE 6

Decoding and Verifying the Encrypted Message

The public key and the modulus are provided on the Internet by the manufacturer of the product (for example the medicine).

The decryption function is

D(x)=x^{d} mod n.

The encrypted message in line with example 4: decimal 241=binary 1111 0001, therefore, is

D(x)=241¹³⁷ mod 391=65.

The decrypted message therefore corresponds to decimal 65, or to binary 0100 0001.

The decrypted information is compared with the unencrypted information to establish the originality.

The decrypted message (A) is: decimal 65=binary 0100 0001, the unencrypted message read from the encrypted data matrix code is likewise decimal 65.

Converting the ASCII representation of the decrypted code and the unencrypted message into a character string gives the message “A” in plain text, said message corresponding to the unencrypted message read from the encrypted data matrix code.

The “A”=“A” comparison shows that the data matrix code on the product was produced using the secret key from the manufacturer. The product is thus authentic.

For decryption and verification, the program described in example 2 was used.

### EXAMPLE 7

Marking a Blister Pack containing a Medicament

To improve handling and to make marking more universal, the unencrypted elements of the message and the encrypted message are shown using two separate data matrix code symbols.

The example was implemented in a manner similar to examples 1 to 6.

The private and public keys were generated using the modulus size of 1024 bits in line with the example.

The message to be encrypted was an individual identification number comprising BATCH No. (40A020), EXP (10.2003), PZN (-0587985) and an individual identifier (00000001).

The individual identification number was encrypted in the following notation

<BATCH>40A020<EXP>10.2003<PZN>-0587985<SN>00000001

into data matrix code ECC200 using the private key, the unencrypted message having been portrayed using data matrix code symbol 1 (in line with a symbol size of 24×24 data matrix moduli) and the encrypted message having been portrayed using data matrix code symbol 2 (in line with a symbol size of 52×52 data matrix moduli).

A blister pack containing a medicament was marked.

The medicament was marked, the information contained in the data matrix code was read and the encrypted message was decrypted and verified in line with examples 4 to 6.

### EXAMPLE 8

Marking a Packaging for a Medicament

In a manner similar to examples 1 to 7, a packaging for a medicament was marked, the modulus size being 1024 bits, the individual identification number comprising PZN, BATCH (batch number) and an individual serial number.

The encryption method was the RSA method.

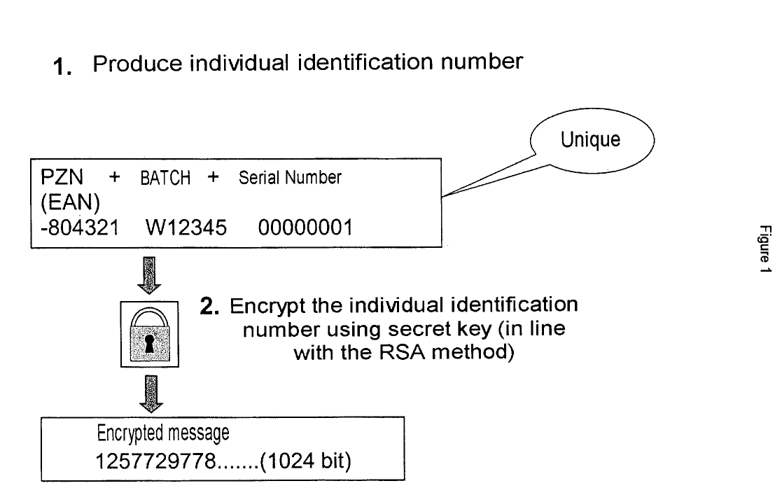

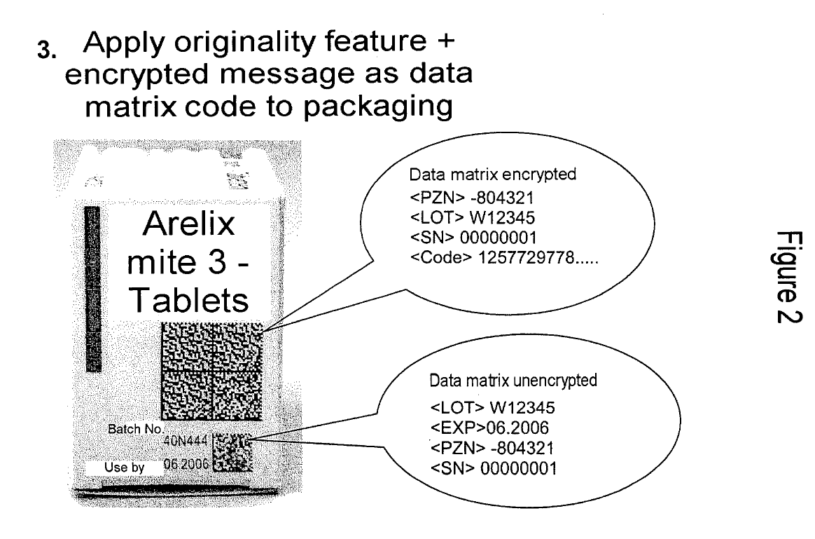

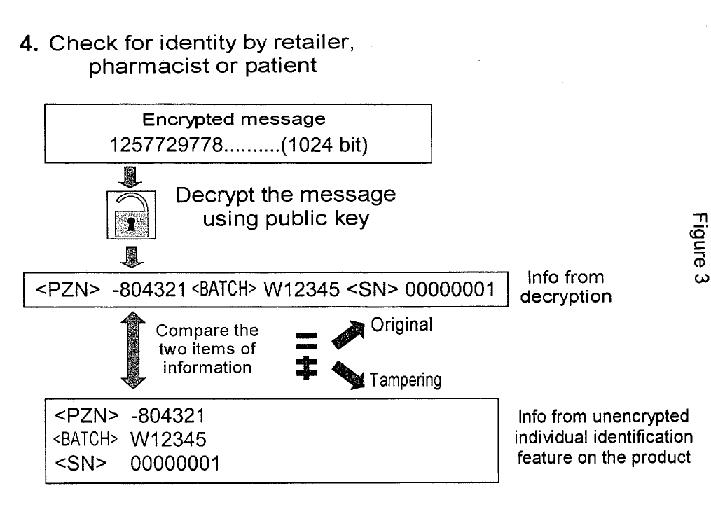

FIGS. 1 to 3 show the inventive method in line with example 8.

While there have been described and pointed out fundamental novel features of the invention as applied to a preferred embodiment thereof, it will be understood that various omissions and substitutions and changes, in the form and details of the packages and methods illustrated, may be made by those skilled in the art without departing from the spirit of the invention. For example, it is expressly intended that all combinations of those elements and/or method steps which perform substantially the same function in substantially the same way to achieve the same results are within the scope of the invention.

The invention is not limited by the embodiments described above which are presented as examples only but can be modified in various ways within the scope of protection defined by the appended patent claims.

We claim:

1. A method of producing a mark by including in said mark at least one originality component which comprises an unencrypted individual identifier and an encrypted individual identifier, said unencrypted identifier having at least one individual identification number and said encrypted identifier being derived from the content of said unencrypted identifier.

2. A method of claim 1, wherein said originality component is provided in plain text or in machine-readable form.

3. A method of claim 2, wherein said unencrypted individual identifier further comprises one or more further features.

4. A commercial product bearing a mark produced by a method of claim 2.

5. A method for preventing tampering of a product by marking said product, the packaging or repackaging thereof, or both said product and said packaging or repackaging, with a mark produced by a method of claim 2.

6. A method of marking a product or its packaging or repackaging with a mark produced by a method of claim 2.

7. A method of claim 6, wherein said product is a pharmaceutical product or a cosmetic product, preferably a blood bank, a blister pack, an ampoule, a vial, a syringe, a tablet, a capsule, a cachet, a lozenge, a plaster, and/or a packaging or repackaging therefor.

8. A method of claim 7, wherein said unencrypted individual identifier of said mark further comprises one or more following further features:
1. an article number, preferably a PZN, an EAN (European Article Number), UPC (Universal Product Code), NDC (National Drug Code) or NHRIC (National Health Related Item Code),
2. a batch number,
3. the date of manufacture,
4. the expiry date, and
5. an identifier for the packaging or repackaging.

9. A method of claim 7, wherein the individual identification number in said unencrypted identifier is formed from one or more items selected from the group consisting of an article number, preferably a PZN, a batch number and a serial number within the batch.

10. A method of claim 7, wherein said originality component of said mark is a one-dimensional code, preferably code 39, extended code 39 or code 128; or a two-dimensional code, preferably 3D barcode, 3-DI, ArrayTag, Aztec code, small Aztec code, codeblock, code 1, code 16K, code 49, CP code, data glyphs, data matrix code, datastrip code, dot code A, hueCode, MaxiCode, MiniCode, PDF417, Micro PDF417, QR code, SmartCode, Snowflake Code, SuperCode or Ultracode; or a combination of one or more one-dimensional code(s) and one or more two-dimensional code(s).

11. A method of claim 7, wherein said originality component of said mark is a data matrix code.

12. A method of claim 7, wherein said encrypted individual identifier is derived from the content of said unencrypted individual identifier using an asymmetric encryption method.

13. A method of claim 12, wherein said asymmetric encryption method is the RSA method.

14. A product marked in accordance with a method of claim 6

15. A product marked in accordance with a method of claim 6, which is a pharmaceutical product or a cosmetic product, preferably a blood bank, a blister pack, an ampoule, a vial, a syringe, a tablet, a capsule, a cachet, a suckable tablet, a plaster, a tube, an inhaler, or a spray bottle.

16. A product marked in accordance with a method of claim 6.

17. A packaging or repackaging marked in accordance with a method of claim 6.

18. A packaging or repackaging of claim 17, which is used for containing a medicine or a cosmetic.

19. A method for detecting product tampering, comprising the steps of
a) marking a product with a mark produced by a method of claim 3;
b) reading, by a purchaser or trader, said originality component of said mark and decrypting said encrypted individual identifier of said originality component using an asymmetric encryption method's public key associated with a secret key to obtain decrypted information from said encrypted individual identifier; and
c) comparing the decrypted information from said encrypted individual identifier with the content of said unencrypted identifier.

20. A method of claim 19, wherein said product is a pharmaceutical product or a cosmetic product, preferably a blood bank, a blister pack, an ampoule, a vial, a syringe, a tablet, a capsule, a cachet, a suckable tablet, a plaster, or a packaging or repackaging therefor.

21. A method of claim 20, wherein said mark further comprises one or more following further features:
1. an article number, preferably a PZN, an EAN (European Article Number), UPC (Universal Product Code), NDC (National Drug Code) or NHRIC (National Health Related Item Code),
2. a batch number,
3. date of manufacture,
4. date of expiration, and
5. an identifier for the packaging or repackaging.

22. A method of claim 20, wherein said individual identification number is formed from an article number, preferably a PZN, batch number and a serial number within the batch.

23. A method of claim 20, wherein said originality component is a one-dimensional code, preferably code 39, extended code 39 or code 128, or a two-dimensional code, preferably 3D bar code, 3-DI, ArrayTag, Aztec code, small Aztec code, coda block, code 1, code 16K, code 49, CP code, data glyphs, data matrix code, datastrip code, dot code A, hueCode, MaxiCode, MiniCode, PDF417, Micro PDF417, QR code, SmartCode, Snowflake Code, SuperCode or Ultracode.

24. A method of claims 20, wherein said originality component is a data matrix code.
